(19) United States
(12) Patent Application Publication
(10) Pub. No.: US 2011/0232523 A1
(43) Pub. Date: Sep. 29, 2011

(54) Method for producing metal nanoparticles, ink composition using the same, and method for producing the same

(75) Inventors: Sung Koo Kang, Suwon (KR); Dong Hoon Kim, Seongnam (KR); Joon Rak Choi, Suwon (KR)

(73) Assignee: SAMSUNG ELECTRO-MECHANICS CO., LTD., Suwon (KR)

(21) Appl. No.: 12/926,891

(22) Filed: Dec. 15, 2010

(30) Foreign Application Priority Data
Mar. 26, 2010 (KR) 10-2010-0027390

(51) Int. Cl. C09D 11/00; B22F 9/16; B82Y 99/00

(52) U.S. Cl. 106/31.13; 75/370; 977/773

(57) ABSTRACT

There are provided a method for producing metal nanoparticles, including: preparing a first solution including a halogen ion-containing metal precursor, an amine, and a non-aqueous solvent; producing a second solution including metal nanoparticles in which the amine is capped by heating, agitating, and reducing the first solution; and washing and drying the second solution with a base-containing solvent in order to remove non-reacted amine and halogen ions from the produced metal nanoparticles in which the amine is capped, an ink composition using the same, and a method for producing the same.

According to an exemplary embodiment of the present invention, the method for producing metal nanoparticles meeting the residual halogen ion concentration regulations, the ink composition using the same, and the method for producing the same can be provided.

### CROSS-REFERENCE TO RELATED APPLICATIONS

This application claims the priority of Korean Patent Application No. 10-2010-0027390 filed on Mar. 26, 2010, in the Korean Intellectual Property Office, the disclosure of which is incorporated herein by reference.

### BACKGROUND OF THE INVENTION

1. Field of the Invention

The present invention relates to a method for producing metal nanoparticles, ink composition using the same, and a method for producing the same, and more particularly, to a method for producing metal nanoparticles meeting residual halogen ion concentration regulations, an ink composition using the same, and a method for producing the same.

2. Description of the Related Art

Since a noncontact direct writing technology using inkjet can discharge a fixed amount of ink to an exact location, it has the advantages of saving material costs and shortening production time.

For industrial inkjet applications, there is a need to develop ink fitting the inkjet. As a result, in order to develop materials for inkjet, much research into a method capable of mass-producing metal particles at low cost has been conducted.

A method of producing particles using a vapor phase method can easily produce nanoparticles. However, the method is complicated, has difficulty in producing a uniform quality of nanopaticles, is more likely to pollute the environment, and has working environment safety issues due to the high risk of explosion during the production process.

On the other hand, a wet particle synthesizing method has, in particular, the advantage of a high yield of nanoparticles. On the other hand, in order to lower the sintering temperature of ink, there is a need to cap the surfaces of particles with a dispersant.

Further, regulations have recently been tightened on electronic materials. In particular, the residual amount of halogen ions, such as chloride, bromine, or the like, has been regulated to 900 PPM or less in electronic materials.

Therefore, a need exists for a new production method meeting the above-mentioned residual halogen ion concentration regulations while mass-producing the metal nanoparticles using a simple method.

### SUMMARY OF THE INVENTION

An object of the present invention is to provide a method for producing metal nanoparticles meeting residual halogen ion concentration regulations, an ink composition using the same, and a method for producing the same.

According to an aspect of the present invention, there is provided a method for producing metal nanoparticles, including: preparing a first solution including a halogen ion-containing metal precursor, an amine, and a non-aqueous solvent; producing a second solution including metal nanoparticles in which the amine is capped by heating, agitating, and reducing the first solution; and washing and drying the second solution with a base-containing solvent in order to remove non-reacted amine and halogen ions from the metal nanoparticles in which the amine is capped.

The method for producing metal nanoparticles may further include dispersing the produced metal nanoparticles into and washing the produced metal nanoparticles with the non-aqueous solvent after the washing and drying.

The metal precursor may include at least one metal selected from a group consisting of gold, silver, copper, nickel, cobalt, platinum, palladium, and an alloy thereof.

The amine may have 6 to 30 carbon atoms and be at least one of a linear type, a branched type, and a cyclic type, and may be at least one selected from a saturated or an unsaturated amine.

The base may be at least one selected from organic bases not including metal elements.

The base may be at least one selected from a group consisting of ammonia, pyridine, methylamine, imidazole, benzimidazole, and histidine.

The base may be added in excess of 0 vol % or less than 20 vol % for 100 vol % of the second solution.

The non-aqueous solvent may be at least one selected from a group consisting of hexane, toluene, xylene, chloroform, dichloromethane, tetradecane, octadecene, chlorobenzoic acid, 1-hexadecene, 1-tetradecene, and 1-octadecene.

The heating of the first solution may be performed at a temperature exceeding 0° C. or less than 100° C.

The method for producing metal nanoparticles may further include measuring the residual halogen ion concentration after the washing and drying.

An another aspect of the present invention, there is provided a method for producing an ink composition, including: preparing a first solution including halogen ions-containing metal precursor, amine, and a non-aqueous solvent; producing a second solution metal nanoparticles capped with an amine by heating, agitating, and reducing the first solution; producing metal nanoparticles by washing and drying the second solution to remove non-reacted amine and halogen ions among the metal nanoparticles capped with the amine with a base-containing solvent; and dispersing the produced metal nanoparticles in the non-aqueous solvent and washing them.

The method for producing an ink composition may further include adding a viscosity modifier to the metal nanoparticle-containing non-aqueous solvent after the dispersing and washing.

The method for producing an ink composition may further include adding a dispersant to the metal nanoparticle-containing non-aqueous solvent after the dispersing and washing.

The viscosity modifier may be added in excess of 0 wt % or less than 20 wt % for 100 wt % of the ink composition.

The dispersant may be added in excess of 0 wt % or less than 20 wt % for 100 wt % of the ink composition.

The metal precursor may include at least one metal selected from a group consisting of gold, silver, copper, nickel, cobalt, platinum, palladium, or an alloy thereof.

The amine may have 6 to 30 carbon atoms and be at least one of a linear type, a branched type, and a cyclic type, and may be at least one selected from a saturated or an unsaturated amine.

The base may be at least one selected from organic bases not including metal elements.

The base may be at least one selected from a group consisting of ammonia, pyridine, methylamine, imidazole, benzimidazole, and histidine.

The base may be added in excess of 0 vol % or less than 20 vol % for 100 vol % of the second solution.

The non-aqueous solvent may be at least one selected from a group consisting of hexane, toluene, xylene, chloroform, dichloromethane, tetradecane, octadecene, chlorobenzoic acid, 1-hexadecene, 1-tetradecene, and 1-octadecene.

The metal nanoparticles may be added in excess of 0 wt % or less than 60 wt % for 100 wt % of the ink composition.

The heating of the first solution may be performed at a temperature in excess of 0° C. or less than 100° C.

The method for producing an ink composition may further include measuring the residual halogen ion concentration after the producing of the metal nanoparticles by performing the washing and drying.

According to another aspect of the present invention, there is provided an ink composition, including: metal nanoparticles containing halogen ions capped with an amine; and a non-aqueous solvent containing a base washing non-reacted amine and halogen ions among the metal nanoparticles.

The ink composition may further include a viscosity modifier modifying the viscosity of ink.

The ink composition may further include a dispersant improving the dispersion of the metal nanoparticles.

The viscosity modifier may be added in excess of 0 wt % or less than 20 wt % for 100 wt % of the ink composition.

The dispersant may be added in excess of 0 wt % or less than 20 wt % for 100 wt % of the ink composition.

The metal nanoparticles may include at least one metal selected from a group consisting of gold, silver, copper, nickel, cobalt, platinum, palladium, and an alloy thereof.

The amine may have 6 to 30 carbon atoms and be at least one of a linear type, a branched type, and a cyclic type, and may be at least one selected from a saturated or an unsaturated amine.

The non-aqueous solvent may be at least one selected from a group consisting of hexane, toluene, xylene, chloroform, dichloromethane, tetradecane, actadecene, chlorobenzoic acid, 1-hexadecene, 1-tetradecene, and 1-octadecene.

The metal nanoparticles may be added in excess of 0 wt % or less than 60 wt % for 100 vol % of the ink composition.

### DETAILED DESCRIPTION OF THE PREFERRED EMBODIMENT

Hereinafter, a method for producing metal nanoparticles according to the present invention and metal nanoparticles produced according to the method will be described in more detail.

The present invention can provide a method for producing metal nanoparticles meeting residual halogen ion concentration regulations, an ink composition using the same, and a method for producing the same

A method for producing metal nanoparticles according to an exemplary embodiment of the present invention includes preparing a first solution including a halogen ion-containing metal precursor, an amine, and a non-aqueous solvent, producing a second solution including metal nanoparticles in which the amine is capped by heating, agitating, and reducing the first solution, and washing and drying the second solution with a base-containing solvent in order to remove non-reacted amine and halogen ions from the metal nanoparticles in which the amine is capped.

The method for producing the metal nanoparticles may further include dispersing the metal nanoparticles into and washing the metal nanoparticles with the non-aqueous solvent after the washing and drying.

In the method for producing the metal nanoparticles according to the present invention, the halogen ions-containing metal nanoparticles capped with an amine are first prepared. In this case, after preparing the solution including the halogen ions-containing metal precursor, the amine, and the non-aqueous solvent, the solution is heated, agitated, and reduced to prepare the metal nanoparticles on which the amine is capped.

In this case, as the metal precursor, at least one metal selected from a group consisting of gold, silver, copper, nickel, cobalt, platinum, palladium, and an alloy thereof and halogen ions-containing materials, for example, HAuCl₄, H₂PtCl₆, CuCl₂, PtCl₄, or the like, may be used.

The amine has 6 to 30 carbon atoms and has at least one of a linear type, a branched type, and a cyclic type, and may be at least one selected from a saturated or an unsaturated amine and may be a primary amine or a secondary amine.

A detailed example of the amine may include hexyl amine, heptyl amine, dodecyl amine, oleyl amine, or the like. At least one thereof may be selected and used. It is preferable that the content of the amine be synthesized at 5 wt % to 30 wt % for 100 wt % of metal nanoparticles. If the content of the amine is below 5 wt %, there may be a problem with safety and if the content thereof exceeds 30 wt %, it is difficult to control viscosity during the production of ink.

Next, the non-reacted amine and halogen ions among the produced metal nanoparticles are washed and dried with a base-containing solvent. Herein, the base may be at least one selected from organic bases that do not include metal. Preferably, the base is at least one selected from a group consisting of ammonia, pyridine, methylamine, imidazole, benzimidazole, and histidine. The reason is that ink is mainly applied to a substrate when the ink including the metal nanoparticles is produced. Therefore, the base is to minimize an affect on the post-process, the sintering process while preventing the interaction of several metal materials on the substrate.

The following reaction formula represents an example of removing the halogen ions by the added basic material according to the exemplary embodiment of the present invention. In this case, the halogen ion, that is, chloride may be removed from the amine capping the metal nanoparticles by forming a compound such as NH₄Cl by adding a basic material such as NH₄OH to NH₃⁺Cl⁻ generated by a combination of H⁺ and Cl⁻ generated from the metal precursor material, HAuCl₄ with the capping agent, a functional group —NH₂ of amine.

—NH₂+H⁺+Cl⁻→NH₃⁺Cl⁻+NH₄OH (base adding)→—NH₂H₂O+NH₄Cl

In this case, the non-aqueous organic solvent usable in the present invention, which is a non-aqueous solvent, may be selected from a group consisting of, for example, hexane, toluene, xylene, chloroform, dichloromethane, tetradecane, octadecene, chlorobenzoic acid, 1-hexadecene, 1-tetradecene, and 1-octadecene. The organic solvent may use one selected therefrom alone or two or more mixture thereof. The organic solvent may be used as it is without extracting and separating the metal particles during the preparing of the metal nanoparticles capped with the amine.

Hereinafter, the degree of removing the residual halogen ions from the halogen-containing metal nanoparticles according to the exemplary embodiment of the present invention will be described with reference to Examples 1 to 3, Comparative Example 1, and Table 1.

Referring to Table 1, after the metal nanoparticles capped with the dodecyl amine of the Comparative Example were washed several times with ethanol only, without a base, the residual chloride ion concentration was slightly reduced from 8410 PPM to 7670 PPM after the synthesis.

TABLE 1

| | Chloride Content | |
|---|---|---|
| | (PPM) | Remarks |
| After synthesis | 8410 | |
| Comparative Example | 7670 | Washed with ethanol |
| | | several times |
| Example 1 | 7900 | Added 1 vol % of |
| | | ammonia during |
| | | washing |
| Example 2 | 1380 | Added 2 vol % of |
| | | ammonia during |
| | | washing |
| Example 3 | 1140 | Added 5 vol % of |
| | | ammonia during |
| | | washing |

In the case of Example 1 of adding a base, 1 vol % of ammonia for the entire solution during the washing, the residual chloride ion concentration was slightly reduced from 8410 PPM to 7900 PPM after the synthesis, but the effect of removing the residual chloride ion was insignificant. However, in the case of Example 2 of adding a base, 2 vol % of ammonia for the entire solution, the residual chloride ion concentration was largely reduced from 8410 PPM to 1380 PPM after the synthesis. Further, in the case of Example 3 of adding a base, 5 vol % of ammonia for the entire solution, the residual chloride ion concentration was even further reduced from 8410 PPM to 1140 PPM after the synthesis. If the added amount of ammonia is increased, the effect of reducing the residual chloride ion concentration is increased; however, the addition of ammonia has an effect on the safety of the metal nanoparticles such that the particles are precipitated without being dispersed in a solution.

### Example 1

A mixing solution of 25 g of hydrogen tetrachloroaurate (HAuCl₄), 80 g of dodecyl amine, and 1 L of toluene was prepared. Next, a gold nanoparticle-containing solution were produced by agitating the solution at 80° C. and reducing it into 3 ml of formic acid.

Thereafter, the chloride ions among the gold nanoparticles capped with the amine were primarily washed with a solvent of ethanol, ammonia water, and the gold nanoparticle-containing solution that was mixed at 5.9:0.1:4 (volume ratio) and then, was centrifugally separated at 3500 rpm for 12 minutes The gold nanoparticles were obtained by removing the supernatant therefrom and drying the sediment.

Next, 25 g of the obtained gold nanoparticles were dispersed in 500 ml of toluene.

Next, ethanol, acetone, and the solution in which the gold nanoparticles were dispersed were mixed at 4:2:4 (volume ratio) and were then centrifugally separated for 15 minutes at 4000 rpm. Thereafter, the gold nanoparticles from which chloride ions are removed were finally obtained by removing and drying the supernatant.

### Example 2

A mixing solution of 25 g of hydrogen tetrachloroaurate (HAuCl₄), 80 g of dodecyl amine, and 1 L of toluene was prepared. Next, a gold nanoparticle-containing solution was produced by agitating the solution at 80° C. and reducing it into 3 ml of formic acid.

Thereafter, the chloride ions among the gold nanoparticles capped with the amine were primarily washed with a solvent of ethanol, ammonia water, and the gold nanoparticle-containing solution that are mixed at 5.8:0.2:4 (volume ratio) and then, were centrifugally separated at 3500 rpm for 12 minutes The gold nanoparticles were obtained by removing the supernatant and drying the sediment.

Next, 25 g of the obtained gold nanoparticles were dispersed in 500 ml of toluene.

Next, ethanol, acetone, and the solution in which the gold nanoparticles were dispersed were mixed at 4:2:4 (volume ratio) and were then centrifugally separated for 15 minutes at 4000 rpm. Thereafter, the gold nanoparticles from which chloride ions are removed were finally obtained by removing and drying the supernatant.

### Example 3

A mixing solution of 25 g of hydrogen tetrachloroaurate (HAuCl₄), 80 g of dodecyl amine, and 1 L of toluene was prepared. Next, a gold nanoparticle-containing solution was produced by agitating the solution at 80° C. and reducing it into 3 ml of formic acid.

Thereafter, the chloride ions, among the gold nanoparticles capped with the amine, were primarily washed with a solvent of ethanol, ammonia water, and the gold nanoparticle-containing solution that were mixed at 5.5:0.5:4 (volume ratio) and then, were centrifugally separated at 3500 rpm for 12 minutes The gold nanoparticles were obtained by removing the supernatant and drying the sediment.

Next, 25 g of the obtained gold nanoparticles were dispersed in 500 ml of toluene.

Next, ethanol, acetone, and the solution in which the gold nanoparticles were dispersed were mixed at 4:2:4 (volume ratio) and were then centrifugally separated for 15 minutes at 4000 rpm. Thereafter, the gold nanoparticles from which chloride ions are removed were finally obtained by removing and drying the supernatant.

### Comparative Example

A mixing solution of 25 g of hydrogen tetrachloroaurate (HAuCl₄), 80 g of dodecyl amine, and 1 L of toluene was prepared. Next, a gold nanoparticle-containing solution was produced by agitating the solution at 80° C. and reducing it into 3 ml of formic acid.

Thereafter, the chloride ions among the gold nanoparticles capped with the amine is primarily washed with a solvent of ethanol and the gold nanoparticle-containing solution that are mixed at 6:4 (volume ratio) and then, was centrifugally separated at 3500 rpm for 12 minutes The gold nanoparticles were obtained by removing the supernatant and drying the sediment.

Next, 25 g of the obtained gold nanoparticles were dispersed in 500 ml of toluene.

Thereafter, the gold nanoparticles from which chloride ions are removed were finally obtained by repeating the process ten times and performing the drying process.

As described above, the method for producing the metal nanoparticles according to the present invention can effectively wash and remove the residual halogen ions during the process of producing the metal nanoparticles obtained at high yield.

A method for producing an ink composition according to another exemplary embodiment of the present invention includes preparing a first solution including halogen ion-containing metal precursor, an amine, and a non-aqueous solvent, producing a second solution metal nanoparticles capped with an amine by heating, agitating, and reducing the first solution, producing metal nanoparticles by washing and drying non-reacted amine and halogen ions among the metal nanoparticles capped with the amine with a base-containing solvent, dispersing the produced metal nanoparticles in the non-aqueous solvent and washing them, and adding a viscosity modifier and a dispersant to the metal nanoparticle-containing non-aqueous solvent.

Further, according to the method for producing the ink composition for a wiring, the ink composition including the metal nanoparticles containing the halogen ions capped with an amine according to another exemplary embodiment of the present invention, the base-containing solvent washing the non-reacted amine and the halogen ions among the metal nanoparticles, the viscosity modifier modifying the viscosity of ink, and the dispersant improving the dispersion of ink can be provided.

The solution in which the halogen ions are removed from the halogen ions-containing metal precursor according to the present invention may be produced by the method for producing the metal nanoparticles described above.

In this case, it is preferable that the viscosity modifier is added at 20 wt % or less for 100 wt % of the entire ink composition. If the content of the viscosity modifier exceeds 20 wt %, the content of the organic matter is increased, such that it is not preferable to form the wiring.

Further, it is preferable that the dispersant is added at 20 wt % or less for 100 wt % of the entire ink composition. If the content of the dispersant exceeds 20 wt %, the content of the organic matter is increased, such that it is not preferable to form the wiring.

The surface of the metal nanoparticles having the structure was capped with the amine and was produced in the non-aqueous system, such that the mixing efficiency with the non-aqueous hydrocarbon-based organic solvent is excellent, thereby making it possible to easily produce the high-concentration metal nanoparticle-containing ink without a separate surfactant.

In addition, the present invention can produce the metal nanoparticle-containing ink meeting the residual halogen ion concentration regulations.

According to the present invention, the ink composition meeting the residual halogen ion concentration regulations and the method for producing the same can be provided.

As set forth above, the present invention can provide the method for producing the metal nanoparticles meeting residual halogen ion concentration regulations, the ink composition using the same, and the method for producing the same.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for producing metal nanoparticles, comprising:
preparing a first solution including a halogen ion-containing metal precursor, an amine, and a non-aqueous solvent;
producing a second solution including metal nanoparticles in which amine is capped by heating, agitating, and reducing the first solution; and
washing and drying the second solution with a base-containing solvent in order to remove non-reacted amine and halogen ions from the metal nanoparticles in which the amine is capped.

2. The method for producing metal nanoparticles of claim 1, further comprising dispersing the produced metal nanoparticles into and washing the produced metal nanoparticles with the non-aqueous solvent after the washing and drying.

3. The method for producing metal nanoparticles of claim 1, wherein the metal precursor includes at least one metal selected from a group consisting of gold, silver, copper, nickel, cobalt, platinum, palladium, or an alloy thereof.

4. The method for producing metal nanoparticles of claim 1, wherein the amine has 6 to 30 carbon atoms and has at least one of a linear type, a branched type, and a cyclic type, and is at least one selected from a saturated or an unsaturated amine.

5. The method for producing metal nanoparticles of claim 1, wherein the base is at least one selected from organic bases not including metal elements.

6. The method for producing metal nanoparticles of claim 5, wherein the base is at least one selected from a group consisting of ammonia, pyridine, methylamine, imidazole, benzimidazole, and histidine.

7. The method for producing metal nanoparticles of claim 5, wherein the base is added in excess of 0 vol % or less than 5 vol % for 100 vol % of the second solution.

8. The method for producing metal nanoparticles of claim 2, wherein the non-aqueous solvent is at least one selected from a group consisting of hexane, toluene, xylene, chloroform, dichloromethane, tetradecane, octadecene, chlorobenzoic acid, 1-hexadecene, 1-tetradecene, and 1-octadecene.

9. The method for producing metal nanoparticles of claim 1, wherein the heating of the first solution is performed at a temperature exceeding 0° C. or less than 100° C.

10. The method for producing metal nanoparticles of claim 1, further comprising measuring the residual halogen ion concentration after the washing and drying.

11. A method for producing an ink composition, comprising:
preparing a first solution including a halogen ions-containing metal precursor, an amine, and a non-aqueous solvent;
producing a second solution metal nanoparticles capped with an amine by heating, agitating, and reducing the first solution;
producing metal nanoparticles by washing and drying the second solution to remove non-reacted amine and halogen ions among the metal nanoparticles capped with the amine with a base-containing solvent; and
dispersing the produced metal nanoparticles in the non-aqueous solvent and washing them.

12. The method for producing an ink composition of claim 11, further comprising adding a viscosity modifier to the metal nanoparticle-containing non-aqueous solvent after the dispersing and washing.

13. The method for producing an ink composition of claim 11, further comprising adding a dispersant to the metal nanoparticle-containing non-aqueous solvent after the dispersing and washing.

14. The method for producing an ink composition of claim 12, wherein the viscosity modifier is added in excess of 0 wt % or less than 20 wt % for 100 wt % of the ink composition.

15. The method for producing an ink composition of claim 13, wherein the dispersant is added in excess of 0 wt % or less than 20 wt % for 100 wt % of the ink composition.

16. The method for producing an ink composition of claim 11, wherein the metal precursor includes at least one metal selected from a group consisting of gold, silver, copper, nickel, cobalt, platinum, palladium, or an alloy thereof.

17. The method for producing an ink composition of claim 11, wherein the amine has 6 to 30 carbon atoms and has at least one of a linear type, a branched type, and a cyclic type, and is at least one selected from a saturated or an unsaturated amine.

18. The method for producing an ink composition of claim 11, wherein the base is at least one selected from organic bases not including metal elements.

19. The method for producing an ink composition of claim 18, wherein the base is at least one selected from a group consisting of ammonia, pyridine, methylamine, imidazole, benzimidazole, and histidine.

20. The method for producing an ink composition of claim 18, wherein the base is added in excess of 0 vol % or less than 20 vol % for 100 vol % of the second solution.

21. The method for producing an ink composition of claim 11, wherein the non-aqueous solvent is at least one selected from a group consisting of hexane, toluene, xylene, chloroform, dichloromethane, tetradecane, octadecene, chlorobenzoic acid, 1-hexadecene, 1-tetradecene, and 1-octadecene.

22. The method for producing an ink composition of claim 11, wherein the metal nanoparticles are added in excess of 0 wt % or less than 60 wt % for 100 wt % of the ink composition.

23. The method for producing an ink composition of claim 11, wherein the heating of the first solution is performed at a temperature exceeding 0° C. or less than 100° C.

24. The method for producing an ink composition of claim 11, further comprising measuring the residual halogen ion concentration after the producing of the metal nanoparticles by performing the washing and drying.

25. An ink composition, comprising:
metal nanoparticles containing halogen ions capped with an amine; and
an non-aqueous solvent containing a base washing non-reacted amine and halogen ions among the metal nanoparticles.

26. The ink composition of claim 25, further comprising a viscosity modifier modifying the viscosity of ink.

27. The ink composition of claim 25, further comprising a dispersant improving the dispersion of the metal nanoparticles.

28. The ink composition of claim 26, wherein the viscosity modifier is added in excess of 0 wt % or less than 20 wt % for 100 wt % of the ink composition.

29. The ink composition of claim 27, wherein the dispersant may be added in excess of 0 wt % or less than 20 wt % for 100 wt % of the ink composition.

30. The ink composition of claim 25, wherein the metal nanoparticles include at least one metal selected from a group consisting of gold, silver, copper, nickel, cobalt, platinum, palladium, or an alloy thereof.

31. The ink composition of claim 25, wherein the amine has 6 to 30 carbon atoms and has at least one of a linear type, a branched type, and a cyclic type, and is at least one selected from a saturated or an unsaturated amine.

32. The ink composition of claim 25, wherein the non-aqueous solvent is at least one selected from a group consisting of hexane, toluene, xylene, chloroform, dichloromethane, tetradecane, octadecene, chlorobenzoic acid, 1-hexadecene, 1-tetradecene, and 1-octadecene.

33. The ink composition of claim 25, wherein the metal nanoparticles are added in excess of 0 wt % or less than 60 wt % for 100 vol % of the ink composition.
